(19) United States
(12) Patent Application Publication
(10) Pub. No.: US 2024/0286957 A1
(43) Pub. Date: Aug. 29, 2024

(54) ROBUST POLYCARBOXYLATE WITH POLYALKYLENE OXIDE-BASED SACRIFICIAL SIDECHAIN LINKAGE AS MILLING AID FOR CEMENTITIOUS MATERIALS

(71) Applicant: CEMEX Innovation Holding AG, Zug (CH)

(72) Inventors: Julien CHAPELAT, Biel/Bienne (CH); Robert WOJTASZCZYK, Nidau (CH)

(21) Appl. No.: 18/571,094

(22) PCT Filed: Jun. 17, 2021
(86) PCT No.: PCT/EP2021/066489

§ 371 Date: Dec. 15, 2023

(51) Int. Cl. C04B 24/26; C04B 28/14; C04B 40/00; C04B 103/52; C08G 81/02

(52) U.S. Cl. CPC C04B 24/2647; C04B 24/2658; C04B 28/14; C04B 40/0046; C08G 81/025; C04B 2103/52

(57) ABSTRACT

The present invention concerns a polycarboxylate ether polymer to be used as a grinding aid during the grinding of cementitious materials, said polymer having sacrificial linkages that preferentially break inside the cement mill. The polymer can have a polycarboxylate ether structure comprising free carboxylic acid groups, neutralized carboxylic acid groups, at least one side chain A and at least one side chain B. The at least one side chain A comprises a group (AlkO)ₘ and the at least one chain B comprises a group (AlkO)ₙ, where AlkO represents an alkylene oxide, and m and n are integers with m<n.

### FIELD OF THE INVENTION

The present invention relates to the use of a new polycarboxylate molecular structure as a grinding aid during the milling of cementitious materials. More particularly, the present invention refers to a new polycarboxylate comb polymer that has an additional polyalkylene oxide-based sacrificial sidechain linkage that, because of the temperature and humidity inside the mill, breaks during the milling process of cementitious materials. This leads to a better interaction between polymer and cementitious material, improving the grinding process and the properties of the final cementitious product.

### BACKGROUND OF THE INVENTION

Cement is a well-known binder, broadly used by the construction industry. Its main constituent is clinker which is ground in a cement mill, together with other optional ingredients, such as pumice, gypsum, limestone, fly ash, slag, or pozzolans. The mixture of these ingredients is called the cement raw meal.

The raw meal is fed to the cement mill, which can be one of four types: ball mill, vertical roller mill, roller press, or horizontal mill. During the grinding process, the temperature reaches 80° C. to 120° C., and cooling water is used, which increases the humidity inside the system.

To achieve high-quality cement, fineness and homogeneity are fundamental. Grinding aids play a key role in ensuring that the specified fineness is attained, while also increasing the overall efficiency of the grinding process.

Grinding aids immediately adsorb on the surface of the freshly grounded particles, neutralizing the electrostatic forces present on their surface which prevents agglomeration. Consequently, the dispersion of the particles is improved.

Conventional grinding aids are, for example, triethanolamine, triethylene glycol, glycerol, triisopropanolamine, ethylene glycol, diethanolamine, diethylene glycol, among others. One class of chemicals that has been tested in recent years as grinding aids is polycarboxylate ethers. This type of comb polymers has been widely used as water reducers or superplasticizers, enabling the production of concrete with up to 30% less water content. Polycarboxylate ethers have been tried as grinding aids during the milling of cementitious materials. There would be some advantages in adding these materials to the cementitious materials in the cement mill, as the produced cement would already have a superplastifying effect. This would not only be advantageous during the milling process, as the molecule will act as a grinding aid, increasing the overall energy efficiency of the process but also the final product would have higher workability and strength gain, as the remaining polycarboxylate ether structure would endow the ground material with higher plasticity with lower water requirement. Nevertheless, these polymeric structures are fragile under the high temperature and humidity inside the mill and might be completely consumed during the milling process, not working anymore as a dispersing agent. Polycarboxylate ethers don't withstand the conditions verified inside the mill, namely temperatures of 80° C. to 120° C. and humidity between 70% and 100%. The sidechains decompose in the mill and the overall superplastifying effect is lost.

Many other applications have tried to increase the robustness of polycarboxylate molecules used as grinding aids. Indeed the prior art has also disclosed comb polymers with carbon backbone to improve the grinding of cementitious materials in the mill. Invariably, these comb polymers are polycarboxylates with sidechains bound to the backbone by ethers, esters, amide, or imide groups. The prior art claims different linkages and different sidechains seeking the perfect molecular structure that is stable under the high temperatures (80-120° C.), mechanical impacts, extreme humidity (70-100%), and high pH (pH>12) verified inside the mill.

For example, EP2379630 discloses the use of polycarboxylate comb polymers containing carbon backbone and pendant polyoxyalkylene groups with ether linkage groups for the milling of cementitious materials. Furthermore, said polyoxyalkylene pendant groups of the polycarboxylate comb polymers should comprise substantially ethylene oxide (“EO”) groups, rather than larger groups, as EO groups would provide extra durability against the harsh environment of the cement grinding mill.

U.S. Pat. No. 8,119,727 also discloses a grinding aid consisting of comb polymers with a carbon backbone, which has polyether groups and functional groups in the form of anionic groups at pH>12.

U.S. Pat. No. 9,458,060 claims the addition of polycarboxylate ether and/or lignosulfonate as a grinding aid that also improves the properties of the mortar or concrete. The polycarboxylate ether is, in particular, a comb polymer that has a polycarboxylate backbone and polyether side chains, wherein the polyether side chains are preferably bound via ester, ether, and/or amide groups to the polycarboxylate backbone. Similarly, also US20160024307 describes a polycarboxylate ether, in particular a comb polymer that has a polycarboxylate backbone and polyether side chains, which are bound preferably via ester, ether, and/or amide groups to the polycarboxylate backbone. In this application, the polycarboxylate ether is combined with special additives.

US20090227709 describes an aqueous polymer to be used as a grinding aid. This polymer should be used in combination with other customary grinding aids, especially amino alcohols.

### DESCRIPTION OF THE INVENTION

The inventors have synthesized a new molecular structure that is robust in the mill, acting as a grinding aid and also providing the final cementitious product with workability and less water requirement. Yet, the inventors of the present invention went a step further and developed a new molecular structure with a “sacrificial” sidechain linkage. This “sacrificial” sidechain linkage is designed to be preferentially destroyed in the mill, with the remaining molecules performing well as a grinding aid, decreasing the overall energy demand of the process but also providing the final building material with workability and strength enhancing properties.

Instead of developing a molecular structure that withstands the milling conditions without breaking, the present inventors have had the breakthrough idea of synthesizing a polymer with “sacrificial” sidechain linkages that are preferably first hydrolyzed during grinding, protecting the main backbone and the main sidechains that make the polymer more efficient as a grinding aid. Furthermore, it was observed that, when milling this new polymer together with cement, the final mortar and concrete properties made with aforesaid cement were improved, especially spread and air content, when compared to a reference cement or even to other state-of-the-art grinding aids.

It was discovered that in the mill, shorter sidechains will preferentially break faster than the longer sidechains, since the strains in the molecule will lead the shorter sidechain to break, resulting in a more energy-preferable state. This means that in a molecule having two or more types of sidechains with different chain length, bonded to the main carbon backbone, the shorter one will break faster, whereas the longer will preferentially stay linked. This means, that the desired polymer structure can be maintained even when submitted to the harsh conditions in the mill.

In short, the inventors have discovered, that a molecule used as a grinding aid that has two or more sidechains, in particular two types of sidechains—A and B—, with A being shorter than B, will see its shorter sidechain A break first in the mill, while sidechain B will remain intact. Sidechain A is therefore referred to as a “sacrificial” sidechain linkage. To achieve such properties, a polymer was synthesized to be used as a grinding aid during the manufacturing of cement (Portland cement or any type of cement or any cement containing various mineral additions in various amounts), pozzolanic materials (natural pozzolan, slag, calcined clay) or lime.

An object of the present invention is therefore a polymer having a polycarboxylate ether structure comprising free carboxylic acid groups, neutralized carboxylic acid groups, at least one side chain A and at least one side chain B, wherein said at least one side chain A comprises a group (AlkO)ₘ and said at least one chain B comprises a group (AlkO)ₙ, wherein AlkO represents an alkylene oxide, and wherein m and n are integers with m<n. Advantageously the side chain B is (AlkO)ₙ—R⁵ wherein R⁵ is a hydrogen atom or C₁ to C₄ alkyl group, alkylaryl group or cycloalkyl group, and the side chain A is (AlkO)ₘ—R⁷ wherein R⁷ is R⁵ or is a bond to another polymer as defined above. The side chains A and B are linked to the backbone by an ester bond.

According to a particular embodiment of the polymer of the present invention, AlkO is a C₂ to C₄ alkylene oxide.

According to a particular embodiment of the polymer of the present invention, (AlkO)ₘ and (AlkO)ₙ are independently chosen from the group consisting of polyethylene glycol, polypropylene glycol, polybutylene glycol, polyoxyethylene glycol, polyoxypropylene amine, and blends thereof.

According to a particular embodiment of the polymer of the present invention, m and n range from 2 to 120.

According to a particular embodiment of the polymer of the present invention, the degree of substitution of side chain A is 0.01 to 0.1 and the degree of substitution of side chain B is 0.1 to 0.4.

According to a particular embodiment of the polymer of the present invention, the polycarboxylate ether structure is based on acrylic or metacrylic acid groups. This gives the polymer water-reducing properties in mortar or concrete materials, as well as dispersing effect and subsequent workability and strength enhancement.

According to a particular embodiment of the present invention, the polymer is represented by the formula (Z), with a polycarboxylate ether backbone and sidechains A and B, having different lengths, linked to the backbone by an ester or amide bond, as shown below:

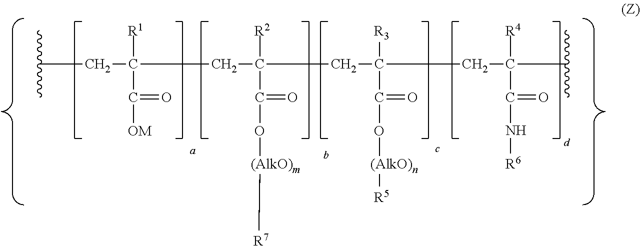

wherein
R¹, R², R³ and R⁴, independently of one another, is a hydrogen atom or a methyl group.
R⁵ is a hydrogen atom or C₁ to C₄ alkyl group, alkylaryl group or cycloalkyl group.
R⁶ is a hydrogen atom or C₁ to C₄ alkyl group, alkylaryl group or cycloalkyl group or (AlkO)ₚ—R⁸, wherein p is an integer ranging from 2 to 120 and R⁸ is a C₁ to C₂ alkyl group.
R⁷ is R⁵ or is a bond to another polymer of formula (Z), and at least one R⁷ group is a bond to another polymer of formula (Z);
a, b, c and d represent the molar percentage of each of the monomers in the structure, and range as follows: a=25-85%; b=1-10%; c=10-40%, d=0-2%.
M, independently, is an AlkO, hydrogen, alkali, or alkaline earth metal cation, ammonium, or any other organic amine group.

In formula (Z), the sequence of monomers with subscripts a, b, c and d is indicative as the organization of substituents is random in the actual polymer.

Any polymer (Z) can be linked to another polymer (Z) through the polyalkylene oxide-based (AlkO)ₘ sidechain linkages (i.e. when R⁷ is a bond). This sidechain linkage, bonding two alike molecules (Z) is sacrificial and intended to preferably break first when exposed to the challenging mill conditions (high temperature, humid and alkaline environment).

Advantageously, the degree of cross-linking may range from 50 to 100%, more advantageously from 50 to 90%.

For example, assuming that the cross-linking reaction is quantitative, the polymer of the present invention may result into the polymer represented by the formula (A) below:

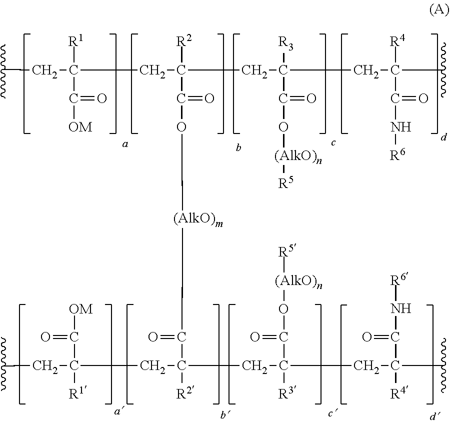

wherein
R¹, R², R³, R⁴, R^{1′}, R^{2′}, R^{3′} and R^{4′}, independently of one another, is a hydrogen atom or a methyl group.
R⁵ and R^{5′} are independently a hydrogen atom or C₁ to C₄ alkyl group, alkylaryl group or cycloalkyl group.
R⁶ and R^{6′} are independently a hydrogen atom or C₁ to C₄ alkyl group, alkylaryl group or cycloalkyl group or (AlkO)ₚ—R⁸, wherein p is an integer ranging from 2 to 120 and R⁸ is a C₁ to C₂ alkyl group.
a, b, c, d, a′, b′, c′ and d′ represent the molar percentage of each of the monomers in the structure; and range as follows: a,a′=25-85%; b,b′=1-10%; c,c′=10-40%, d,d′=0-2%;
M is AlkO, hydrogen, alkali, or alkaline earth metal cation, ammonium, or any other organic amine group.

Inside the mill, as the temperature reaches 80° C. to 120° C., and the humidity reaches values close to 100%, ester linkages are hydrolyzed. The typical residence time of a grinding aid molecule in a cement mill is between 1 and 10 minutes, which is the duration time of exposure to the conditions mentioned above. The grinding “action” is happening almost instantly, so the residence time strongly depends on the length of the mill being used. The inventors have discovered that the “sacrificial” shorter sidechain linkages bonding two polymers (Z) are weaker in these conditions than the longer sidechains needed for the comb polymer to provide with dispersing effect and subsequent workability and strength enhancement. This is notably due to the difference in hydrolysis kinetic rates as the length of the AlkO is shorter for the sacrificial sidechain linkage than the main sidechain (m<n), and due to the entropic energy favoring the molecular structure to adopt a lower energy conformation while removing the linkage between (Z) polymers. It was verified that close to 100% of the “sacrificial” linkages are broken during the milling process.

Once the “sacrificial” linkage is broken, the remaining molecular structures still possess a great affinity to the surface of cementitious particles due to electrostatic interactions, dispersing them inside the mill. This prevents agglomeration of the cementitious materials inside the mill, improving their flowability, which allows better grinding, resulting in a higher fineness and a higher specific area. This also translates into a more energy-efficient process. It was verified that using the polycarboxylate hereby disclosed as a grinding aid allows a reduction in energy consumption (kWh/t) by 40% when compared to a process without any grinding aid and up to 15% when compared to a regular grinding aid.

A second advantage of the present invention is that, since molecule (Z) is a polycarboxylate ether, it will also provide the final mortar or concrete product with desirable properties, such as high fluidity with less water requirement.

It was verified that adding this polymer directly into the cement when preparing mortar or concrete, would provide a limited increase in plasticity and lower water requirement compared to a regular polycarboxylate ether molecule.

According to a particular embodiment of the present invention, the polymer's backbone has an averaged molecular weight between 1000 and 20000 Da, more preferably between 2500 and 15000 Da, even more preferably between 5000 and 10000 Da. Typical final molecular weight of the polymer lays between 10000 and 100000 Da, more preferably 15000 and 80000 Da and even more preferably between 20000 and 65000 Da. The proper final molecular weight ensures the polymer acts as a grinding aid but also has its water-reducing and strength enhancements properties.

Another object of the present invention is also a method to use a polymer as a grinding aid during the manufacturing of cement (Portland cement or any type of cement or any cement containing various mineral additions in various amounts), pozzolanic materials (natural pozzolan, slag, calcined clay) or lime, that is characterized in:
a) Providing a fresh feed to a cement mill;
b) Adding a polymer of the present invention as defined above to the cement mill,
c) Grinding the material obtained in step b) until the material reaches the final desired fineness according to the final cementitious product being produced;
d) Discharge the final product from the cement mill.

According to a particular embodiment of the method of the present invention, the polymer is added to the cement mill together with the fresh feed, through the mill's fresh feed chute, or directly into the first chamber of the cement mill, before or during the grinding of the cementitious materials. It was observed that there is no significant difference in adding it to the fresh feed or directly to the first chamber of the cement mill. According to a particular embodiment of the method of the present invention, the polymer is added in an amount between 0.01 wt. % and 0.4 wt. % based on the dry weight of the cementitious material to be ground. These dosages are typical for any grinding aid.

According to a particular embodiment of the method of the present invention, the polymer, the residence time of the polymer inside the cement mill is between 1 and 10 minutes. After the milling process, the cementitious particles are stored in a silo. Since the particles are stored still warm, at a temperature between 50° C. and 70° C., the polycarboxylate ether molecules can still interact with the cementitious particles, improving the final performance in the mortar or concrete products.

According to a particular embodiment of the method of the present invention, a defoamer can be added before or after the grinding process to control de amount of air in the final product, in a dosage ranging between 0.1 wt. % and 0.5 wt. %, based on the wet weight of the added polymer. The addition of a defoamer will depend on the final product and if air entrainment is a desirable characteristic of said product. Examples of defoamers are, as an example but not limited to, tributylphosphate (TBP), tri-isobutylphosphate (TiBP), dibutylphtalate, silicones, esters, amines, or carbonic acids.

According to the present invention, the polymer can also be used in combination with known grinding aids, as an example but not limited to, ethanolamines such as triethanolamine (TEA) and triisopropanolamine (TIPA) along with glycols such as diethylene glycol (DEG) and propylene glycol (PG). Adding known grinding aids with the polymer hereby described increases the grindability and processability of the cementitious material, and also increases the strength and workability of the final product (mortar or concrete).

Furthermore, the polymer can be delivered both as powder and/or in solution. The polymer will work either as a powder or in a solution.

Preferably, the cementitious material according to the invention comprises Portland cement, cement clinker, limestone, natural pozzolan, fly ash, granulated blast furnace slag, or mixture thereof. More preferably, said cementitious material is cement clinker.

The present invention may be used in conventional grinding mills used by the cement industry, such as ball mills.

### BRIEF DESCRIPTION OF THE FIGURES

FIG. 1 represents nine cement samples separately ground in a ball mill.

### EXAMPLES

### Material Preparation

In all examples, a closed circuit ball mill with the following characteristics was used:

TABLE 1
Experimental ball mill details
Bond ball mill details

| | |
|---|---|
| Internal diameter (m) | 0.3048 |
| Internal length (m) | 0.3048 |
| Mill speed (rpm) | 70 |
| Mill speed (fraction of critical speed) | 0.91 |
| Ball load (% by volume) | 19.27 |
| Total mass of balls (g) | 21125 |
| Ball top size (mm) | 36.38 |
| Geometry of mill liner | Smooth |
| Grinding type | dry |

The grinding conditions of the closed circuit ball mill were:
heating jacket set to 120° C.;
2.5 mL of water per hour being dripped into the raw materials feeder (an equivalent of 500 ppm on the 5 kg/hr production assumption);

In all examples, mortar preparation was done according to the EN-196 norm. Spreads at 5 (t₅) and 30 (t₃₀) minutes are measured on the EN flow table.

In all examples, the mortar mix design was made of 450 g of cement, 225 ml of water, and 1350 g of sand, according to the EN-196 norm.

### Example 1

A raw meal was first homogenized with the use of an automatic homogenizer and then split into four samples, each sample intended to be milled separately and with one of four different grinding aids:
1) Polycarboxylate Ether (PCE) based on the molecular structure (Z) but without a “sacrificial” linkage, with a dosage 0.1 wt % based on the dry weight of the cementitious material to be ground (50% Active Solid Content (ASC)).
2) PCE with molecular structural (A) (two (Z) molecules connected by a “sacrificial” linkage): R¹═R³=R⁴═R^{3′}═R^{4′}=hydrogen; R²═R^{1′}═R^{2′}=methyl group, m=17, n=70, a=a′=80, b=b′=3, c=c′=16, d=d′=1, Alk=ethylene, with a dosage 0.1 wt % based on the dry weight of the cementitious material to be ground (50% Active Solid Content (ASC)).
3) PCE with molecular structural (A) (same as sample 2)), with a dosage 0.2 wt % based on the dry weight of the cementitious material to be ground (50% Active Solid Content (ASC)).
4) Grinding aid based on lignosulfonate, with a dosage 0.1 wt % based on the dry weight of the cementitious material to be ground (50% Active Solid Content (ASC)).

The raw meal was composed of the following raw materials:
70% clinker
25% limestone
5% gypsum

The samples were ground until the final material had a fineness d₉₀=45 μm, where d₉₀ means a particle dimension corresponding to 90% of the cumulative undersize distribution.

After grinding, water and sand were added to the samples, with a water/cement ratio of 0.5, and a defoamer tributylphosphate (0.1 wt % based on the wet weight of the added polymer) was also added.

TABLE 2
Results from Example 1

| | | | | 4) |
|---|---|---|---|---|
| | 1) | 2) | 3) | Lignosul- |
| | PCE without | PCE with | PCE with | fonate |
| | sacrificial | sacrificial | sacrificial | (Formu- |
| Sample | linkage | linkage | linkage | lation) |
| w/c | 0.5 | 0.5 | 0.5 | 0.5 |
| PCE dosage | 0.1% (as | 0.1% (as | 0.2% (as | 0.1% (as |
| (wt %) | 50% ASC) | 50% ASC) | 50% ASC) | 50% ASC) |
| Defoamer dosage | 0.1 | 0.1 | 0.1 | 0.1 |
| (wt %) | | | | |
| density [g/cm³] | 2.226 | 2.222 | 2.209 | 2.202 |
| t₅ [mm] | 180 | 19 | 186 | 186 |
| t₃₀ [mm] | 169 | 185 | 178 | 173 |
| Mill Energy [kWh/t] | 33 | 27 | 31 | 32 |
| Separator speed [rpm] | 1495 | 1300 | 1375 | 1450 |

The spread was measured 5 minutes (t₅) and 30 minutes (t₃₀) after starting the mix.

As we see from

, the spreads in samples 2 and 3, using the PCE described in the present invention, have better values than in sample 1, without the sacrificial linkage, and sample 4 using a lignosulfonate formulation (with additions aiding the grinding process). Table 2 also provides us with the energy reduction that we are gaining when using the PCE described in the present invention. The energy needed to grind a sample without any additions (Reference blank cement, not reported in this table) was 40% (37 kWh/t) more compared to the milling performed with the PCE described in this invention.

### Example 2

To simulate the conditions in the silos, and see if the polymer would decompose or the cement would show a different behavior, the first three cement samples ground in Example 1 were removed from the mill and kept for 60 hours in a curing chamber with a Relative Humidity of 80% and a temperature of 60° C.

After 60 hours, sand and water were added to the samples in a water-to-cement ratio of 0.5. Results are shown in Table 3.

TABLE 3
Results from Example 2

| | | | | 4) |
|---|---|---|---|---|
| | 1) | 2) | 3) | Lignosul- |
| | PCE without | PCE with | PCE with | fonate |
| | sacrificial | sacrificial | sacrificial | (Formu- |
| Sample | linkage | linkage | linkage | lation) |
| w/c | 0.5 | 0.5 | 0.5 | 0.5 |
| PCE dosage | 0.1% (as | 0.1% (as | 0.2% (as | 0.1% (as |
| (wt %) | 50% ASC) | 50% ASC) | 50% ASC) | 50% ASC) |
| Defoamer dosage | 0.1 | 0.1 | 0.1 | 0.1 |
| (wt %) | | | | |
| density [g/cm³] | 2.203 | 2.207 | 2.210 | 2.185 |
| t₅ [mm] | 189 | 196 | 193 | 182 |
| t₃₀ [mm] | 178 | 188 | 186 | 176 |

The mortars prepared with the cement ground with the PCE of the invention present higher values for spread after 5 and 30 minutes, even after 60 hours in a curing chamber. This means that not only the PCE is stable, even after 60 hours in a curing chamber with a Relative Humidity of 80% and a temperature of 60° C., but its effect is enhanced when it is allowed to interact with the cement before being mixed in the mortar.

### Example 3

For this example, nine cement samples were separately ground in the ball mill. The reference cement had the same composition as in example 1 (70% clinker, 25% limestone, 5% gypsum). The samples were ground until the final material had a fineness d₉₀=45 μm, where d₉₀ means a particle dimension corresponding to 90% of the cumulative undersize distribution. Different polymers were added to the samples, at different stages of the process. The polymers were added in a dosage 0.1 wt % based on the dry weight of the cementitious material (50% Active Solid Content (ASC)) and the defoamer (tributylphosphate), when used, was added in a dosage 0.1 wt % based on the wet weight of the added polymer.
Sample 1: Blank. Only cement (no polymer added at any stage of the grinding process);
Sample 2: Reference cement ground alone. After exiting the mill, the PCE of the invention according to structure (A) (PCE I) was added to the cement, as well as the defoamer.
Sample 3: Reference cement ground alone. After exiting the mill, the PCE of the invention according to structure (A) (PCE I) was added to the cement. No defoamer was used.
Sample 4: Reference cement ground together with the PCE of the invention according to structure (A) (PCE I). After the material exited the mill, the defoamer was added.
Sample 5: Reference cement ground together with the PCE of the invention according to structure (A) (PCE I). No defoamer was added.
Sample 6: Reference cement ground alone. After exiting the mill, a commercial PCE was added to the cement, as well as the defoamer.
Sample 7: Reference cement ground alone. After exiting the mill, a commercial PCE was added to the cement. No defoamer was used.
Sample 8: Reference cement ground together with the commercial PCE. After the material exited the mill, the defoamer was added.
Sample 9: Reference cement ground together with the commercial PCE. After the material exited the mill. No defoamer was used.

Nine mortar samples were mixed using each of the ground samples described above. Spread, air content, and strength at 1, 7, and 28 days were measured.

TABLE 4
Results from Example 3

| | PCE with Sacrificial sidechain linkage (PCE I) | | | | Traditional PCE (PCE II) | | | |
|---|---|---|---|---|---|---|---|---|
| BLANK | | 3. Reference | | | | 7. Reference | | |
| 1. Reference | 2. Reference | Cement + | | 5. PCE I | 6. Reference | Cement + | | 9. PCE II |
| Cement − | Cement + | PCE I | 4. PCE I | Cement | Cement + | PCE II | 8. PCE II | Cement |
| Blank | PCE I | (no def.) | Cement | (no def.) | PCE II | (no def.) | Cement | (no def.) |
| w/c = 0.50 | w/c = 0.50 | w/c = 0.50 | w/c = 0.50 | w/c = 0.50 | w/c = 0.50 | w/c = 0.50 | w/c = 0.50 | w/c = 0.50 |

SPREAD

| | | | | | | | | | |
|---|---|---|---|---|---|---|---|---|---|
| t₅ [min] | 185 | 192 | 196 | 192 | 200 | 193 | 196 | 191 | 198 |
| t₃₀ [min] | 174 | 182 | 179 | 186 | 182 | 183 | 180 | 180 | 181 |

AIR CONTENT

| | | | | | | | | | |
|---|---|---|---|---|---|---|---|---|---|
| Air [%] | 4.19 | 3.04 | 5.99 | 2.55 | 6.25 | 2.27 | 5.65 | 2.34 | 5.98 |

STRENGTH

| | | | | | | | | | |
|---|---|---|---|---|---|---|---|---|---|
| 1 D | 5.4 | 5.8 | 4.9 | 5.7 | 4.8 | 5.3 | 5.1 | 5.1 | 5.0 |
| 7 D | 31.9 | 36.2 | 27.3 | 36.6 | 27.5 | 36.2 | 27.1 | 36.0 | 28.1 |
| 28 D | 45.3 | 48.6 | 41.1 | 47.8 | 41.3 | 48.3 | 41.8 | 48.6 | 42.3 |

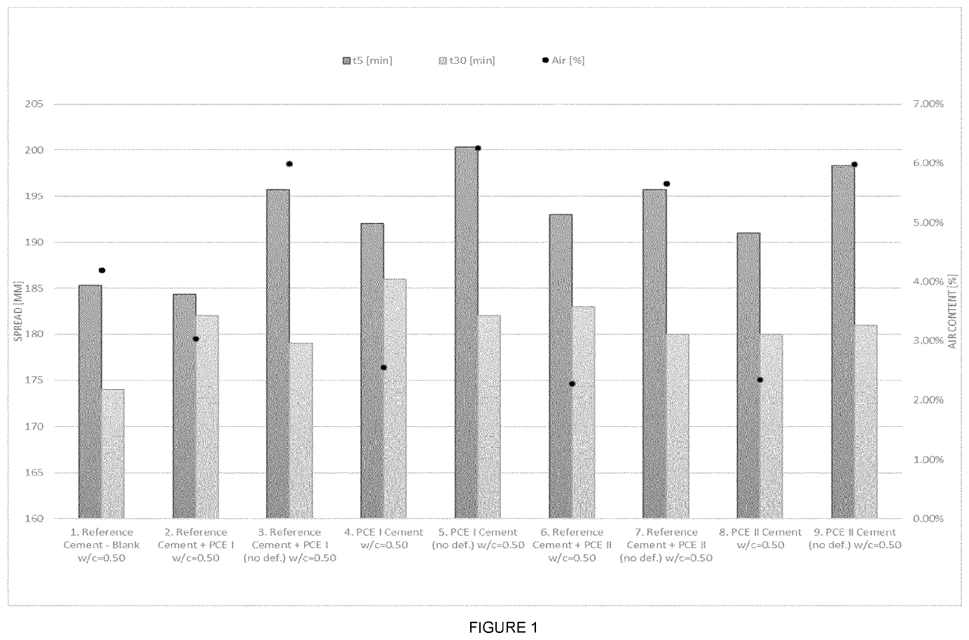

The results are shown in FIG. 1.

From the air contents, we see that the PCE according to the invention also acts as an air entrapper, like commercial PCEs. This is an advantage when applications with entrained air are needed. When this is not required, defoamers can successfully be used.

The spreads were comparable or even better than when the commercial PCE was used.

### Example 4

To validate the invention, more samples were mixed and the data were compared. This cross-checking process further proves the advantage of the invention.

The samples consisted of:
Sample 1: Blank. Only cement (no polymer added at any stage of the grinding process);
Sample 2: Reference cement ground together with the PCE of the invention according to structure (A).
Sample 3: Reference cement ground together with the PCE of the invention according to structure (A), and cured for 60 hours in a curing chamber (Relative Humidity of 80% and a temperature of 60° C.);
Sample 4: Reference cement ground together with the PCE of the invention according to structure (A), and cured for 60 hours in a curing chamber (Relative Humidity of 80% and a temperature of 60° C.);
Sample 5: Reference cement ground together with a PCE based on the molecular structure (Z) but without a “sacrificial” linkage.
Sample 6: Reference cement ground together with a PCE based on the molecular structure (Z) but without a “sacrificial” linkage, and cured for 60 hours in a curing chamber (Relative Humidity of 80% and a temperature of 60° C.);
Sample 7: Reference cement ground together with the commercial PCE (PEMA 300N).

The reference cement had the same composition as in example 1 (70% clinker, 25% limestone, 5% gypsum). The samples were ground until the final material had a fineness d₉₀=45 μm, where d₉₀ means a particle dimension corresponding to 90% of the cumulative undersize distribution. The polymers were added in a dosage 0.1 wt % based on the dry weight of the cementitious material (50% Active Solid Content (ASC)), except in sample 4 where 0.2 wt % based on the dry weight of the cementitious material (50% Active Solid Content (AS2)) was used. A defoamer (tributy phosphate), in a dosage 0.1 wt % based on the wet weight of the added polymer, was added to all samples before mortar preparation.

After grounded, sand and water were added to the samples to prepare seven samples of mortars.

Table 5 reports the best results obtained.

TABLE 5
Results from Example 4

| | | | | | | | |
|---|---|---|---|---|---|---|---|
| | | 3. PCE | 4. PCE | | 6. PCE | | |
| | | (1000 ppm) | (2000 ppm) | | (1000 ppm) | | 8. Traditional |
| | 2. PCE | with | with | 5. PCE | without | | PCE (1000 |
| | (1000 ppm) | sacrificial | sacrificial | (1000 ppm) | sacrificial | | ppm) |
| | with | linkage | linkage | without | linkage | 7. Traditional | Cement |
| 1. Reference | sacrificial | Cement \| | Cement \| | sacrificial | Cement \| | PCE (1000 | \| 60 h |
| Cement − | linkage | 60 h curing | 60 h curing | linkage | 60 h curing | ppm) | curing |
| Blank \| | Cement \| | chamber \| | chamber \| | Cement \| | chamber \| | Cement \| | chamber \| |
| w/c = 0.50 | w/c = 0.50 | w/c = 0.50 | w/c = 0.50 | w/c = 0.50 | w/c = 0.50 | w/c = 0.50 | w/c = 0.50 |

SPREAD

| | | | | | | | | |
|---|---|---|---|---|---|---|---|---|
| t₅ [min] | 185 | 192 | 196 | 193 | 182 | 187 | 191 | 194 |
| t30 [min] | 174 | 186 | 188 | 186 | 172 | 178 | 180 | 177 |

AIR CONTENT

| | | | | | | | | |
|---|---|---|---|---|---|---|---|---|
| Air [%] | 5.1 | 3.1 | 4.0 | 3.8 | 3.3 | 3.5 | 3.4 | 3.2 |

### LIST OF DEFINITIONS

Admixture. Chemical species used to modify or improve concrete's properties in fresh and hardened state. These could be air entrainers, water reducers, retarders, superplasticizers, and others.

Air content. The volume of air voids in cement paste, mortar, or concrete.

Air entrainer. An admixture that ensures air bubbles are trapped inside the material.

Agglomeration. When particles stick to each other or surfaces they agglomerate, leading to buildup, caking, or lumping.

Aggregates. A broad category of fine to coarse particulate material used in construction, including sand or gravel. Also see the definitions for sand, fine and coarse aggregates.

Alkali. Basic, ionic salt of an alkali metal or an alkaline earth metal.

Alkaline. Material that has alkali or has a pH higher than 7.

Amide. Chemical compound with the general formula RC(═O)NR′R″, where R, R′, and R″ represent organic groups or hydrogen atoms.

Backbone. The backbone of a polymer is the longest chain of covalently bonded atoms, forming the continuous chain of the molecule.

Binder. It is a material with cementing properties that sets and hardens due to hydration even underwater. Hydraulic binders normally also contain mineral additions like fillers, limestone, and supplementary cementitious materials (SCMs) like fly ash, slag, pozzolan, thermally or mechanically activated clay, etc.

Blaine. Is a standard test method for powdered material to measure the fineness of powdered material, such as cement, usually expressed as a surface area in square centimeters per gram.

Bond. A chemical connection that joins molecules.

Building material. Any material that can be used to build construction elements or structures. It includes concrete, masonries (bricks—blocks), stone, ICF, etc.

Cement. It is a binder that sets and hardens and brings materials together. The most common cement is the ordinary Portland cement (OPC) and a series of Portland cements blended with other cementitious materials.

Cement mill. A cement mill is a piece of equipment used in the continuous cement grinding process to grind the clinker from the cement kiln into the fine grey powder that is cement.

Degree of substitution (DS). The DS of the polymer is the (average) number of substituent groups attached per monomeric unit.

Fresh feed. Stream of material that enters the ball mill. This material comprises mainly clinker but also gypsum and additions.

Cementitious materials. Materials that have the properties of cement. In the present invention, cementitious materials refer to cement and supplementary cementitious materials (SCMs).

Clinker. Also hereby mentioned as Portland clinker. Produced by heating limestone and aluminosilicate materials, such as clay, at temperatures of about 1,450° C. Portland clinker is the main component of Ordinary Portland Cement.

Coarse Aggregates. Manufactured, natural, or recycled minerals with a particle size greater than 8 mm and a maximum size lower than 32 mm.

Comb polymer. Class of branched polymers consisting of a linear backbone with grafted side chains.

Compressive strength. The capacity of a material or structure to withstand compressive load before fracturing.

Concrete. Building material that becomes hard upon hydration, made of a hydraulic binder, sand, fine and/or coarse aggregates, and water. Admixture can also be added to provide specific properties such as flow, lower water content, acceleration, etc.

Defoamer. A chemical additive that avoids or reduces the formation of foam in industrial process liquids.

Electrostatic interactions. The attractive or repulsive interaction between particles having electric charges.

Ester. A chemical compound with the general formula RCO₂R′, where R and R′ are the hydrocarbon parts of the carboxylic acid and the alcohol, respectively.

Ether. A chemical compound with the general formula R—O—R′, where R and R′ represent the alkyl or aryl groups.

Fine Aggregates. Manufactured, natural, or recycled minerals with a particle size greater than 4 mm and a maximum size lower than 8 mm.

Fineness. Estimation of how fine a powdered material is. Normally measured by passing the material through sieves with different mesh sizes and registering how much of said particles are retained and how much passes through. Laser granulometry or Blaine test can also be applied to characterize fineness.

Flowability. The ability of a powder to flow under a specified set of conditions, for example, the pressure on the powder, the humidity, and the type of equipment where the powder is flowing.

Fluidity. The physical property of a substance that enables it to flow.

Fly ash. Ash produced from burning coal.

Granulated blast furnace slag. The product that is obtained by quenching molten iron slag from a blast furnace in water or steam.

Grinding or milling. The mechanical process used to reduce a material to a powder or small fragments by friction or abrasion (as in a mill).

Grinding medium. Objects, such as balls, used to refine material and reduce particle size.

Grinding aid. Also called a grinding agent or grinding additives. Chemical components that are added to the clinker to aid in the reduction process of the clinker into powder.

Humidity. A representation of the amount of water vapour in the atmosphere or in a gas.

Hydration. It is the mechanism through which Ordinary Portland Cement or other inorganic materials react with water to develop strength. Calcium silicate hydrates are formed and other species like ettringite, monosulfate, Portlandite, etc.

Imide. A chemical compound containing the group —CONHCO—, related to ammonia by replacement of two hydrogen atoms by acyl groups.

Kinetic energy. Kinetic energy is a property of a moving object or particle and depends not only on its motion but also on its mass. When the temperature of an object increases, the average kinetic energy of its particles increases.

Lime. A white caustic alkaline substance consisting of calcium oxide.

Limestone. A rock, mainly made of calcium carbonate or dolomite, used as building material and as raw material in cement production.

Linkage. Same as Bond. A connector between two atoms or molecules.

Mill. Same as Cement mill.

Molecule. A group of two or more atoms held together by chemical bonds or linkages.

Molecular structure. The location of the atoms, groups or ions relative to one another in a molecule.

Monomer. A molecule that can react with other monomer molecules to form an oligomer and then a polymer.

Mortar. A building material made of cement, sand and water, normally used between bricks or stones to held them together once it hardens.

Natural pozzolan. Raw or calcined pozzolan that is found in natural deposits.

Ordinary Portland cement (OPC). A hydraulic cement made from grinding clinker with gypsum. Portland cement contains calcium silicate, calcium aluminate, and calcium ferroaluminate phases. These mineral phases react with water to produce strength.

Pendant groups. Group of atoms attached to a backbone chain of a long molecule, usually a polymer.

Polycarboxylate ethers. Polymers widely used in concrete chemistry as water reducers.

Polymer. Material with a high molecular weight made of many monomers.

Pozzolan. Silicate-based materials that react with calcium hydroxide generated from the cement hydration process to form additional cementitious materials.

Raw meal. The mixture of the raw materials before entering the mill, such as clinker, limestone, fly ash, slag, clay, etc.

Sacrificial. According to the invention, a sacrificial linkage is designed to be destroyed in fulfilling the purpose of the invention.

Sand. Manufactured, natural, or recycled minerals with a particle size lower than 4 mm.

Sidechain. A group of atoms attached to the main part of a molecule.

Silo. A structure used to store and discharge powder materials.

Specific area. The total surface area of a material per unit of mass.

Spread. The extent, width, or area covered by the concrete or mortar.

Strength development—setting/hardening. The setting time starts when the construction material changes from plastic to rigid. In the rigid stage, the material cannot be poured or moved anymore. After this phase the strength development corresponding to the hardening of the material.

Superplasticizers. It relates to a class of chemical admixture used in hydraulic cement compositions such as Portland cement concrete having the ability to highly reduce the water demand while maintaining a good dispersion of cement particles. Superplasticizers avoid particle aggregation and improve the rheological properties and workability of cement and concrete at the different stages of the hydration reaction.

Supplementary cementitious materials. Materials that, when used together with cement, contribute to the properties of hardened concrete through hydraulic and/or pozzolanic activity.

Water reducer. Admixture added to concrete or similar construction material to reduce the amount of water needed in the mix design while achieving the same final properties.

Water requirement. The amount of water needed to hydrate per dry weight of product.

Water-to-binder ratio. Also described as w/b. Total free water (w) mass in Kg divided by the total binder mass (b) in Kg.

In summary, the polymer hereby disclosed provides advantages as a grinding aid during the milling of cementitious materials. Contrary to other polycarboxylate ethers, that are destroyed in the mill due to high humidity, temperature, and pH inside the mill, the polymer hereby disclosed is robust and endures the milling process of cementitious materials. As it combines with the cementitious particles, it also provides the final construction material (mortar or concrete) with properties given by superplasticizer PCEs, such as higher workability and strength gain.

1. A polymer having a polycarboxylate ether structure comprising free carboxylic acid groups, neutralized carboxylic acid groups, at least one side chain A and at least one side chain B, wherein said at least one side chain A comprises a group (AlkO)ₘ and said at least one chain B comprises a group (AlkO)ₙ, wherein AlkO represents an alkylene oxide, and wherein m and n are integers with m<n.

2. A polymer according to claim 1, wherein AlkO is a C₂ to C₄ alkylene oxide.

3. A polymer according to claim 1, wherein (AlkO)ₘ and (AlkO)ₙ are independently chosen from the group consisting of polyethylene glycol, polypropylene glycol, polybutylene glycol, polyoxyethylene glycol, polyoxypropylene amine, and blends thereof.

4. A polymer according to claim 1, wherein m and n range from 2 to 120.

5. A polymer according to claim 1, wherein the degree of substitution of (AlkO)ₘ is 0.01 to 0.1.

6. A polymer according to claim 1, wherein the degree of substitution of (AlkO)ₙ is 0.1 to 0.4.

7. A polymer according to claim 1, wherein the polymer is represented by the formula (Z) below: 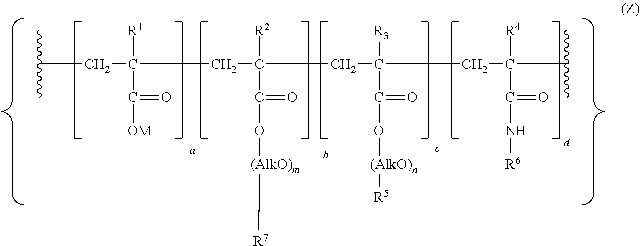
wherein
R¹, R², R³ and R⁴, independently of one another, is a hydrogen atom or a methyl group.
R⁵ is a hydrogen atom or C₁ to C₄ alkyl group, alkylaryl group or cycloalkyl group.
R⁶ is a hydrogen atom or C₁ to C₄ alkyl group, alkylaryl group or cycloalkyl group or (AlkO)ₚ—R⁸, wherein p is an integer ranging from 2 to 120 and R⁸ is a C₁ to C₂ alkyl group.
R⁷ is R⁵ or is a bond to another polymer of formula (Z); providing that R⁷ is at least bond to one polymer of formula (Z).
a, b, c and d represent the molar percentage of each of the monomers in the structure, and range as follows: a=25-85%; b=1-10%; c=10-40%, d=0-2%.
M, independently, is an AlkO, hydrogen, alkali, or alkaline earth metal cation, ammonium, or any other organic amine group.

8. A polymer according to claim 1, wherein the polymer's backbone has an averaged molecular weight between 1000 and 20000 Da, more preferably between 2500 and 15000 Da, even more preferably between 5000 and 10000 Da.

9. A polymer according to claim 1, wherein the polymer's molecular weight is between 10000 and 100000 Da, more preferably 15000 and 80000 Da and even more preferably between 20000 and 65000 Da.

10. A method to use a polymer as a grinding aid during the manufacturing of cement, pozzolanic materials, or lime, that is characterized in:
a) Providing a fresh feed to a cement mill;
b) Adding a polymer according to claim 1;
c) Grinding the material obtained in step b) until the material reaches the final desired fineness according to the final cementitious product being produced;
d) Discharge the final product from the cement mill.

11. The method according to claim 10, wherein the polymer is added to the cement mill together with the fresh feed.

12. The method according to claim 10, wherein the polymer is added directly into the first chamber of the cement mill.

13. The method according to claim 10, wherein the polymer is added in an amount between 0.01 wt. % and 0.4 wt. % based on the dry weight of the cementitious material to be ground.

14. The method according to claim 10, wherein the residence time of the polymer inside the cement mill is between 1 and 10 minutes.

15. The method according to claim 10, wherein a defoamer can be added before or after the grinding process in a dosage ranging between 0.1 wt. % and 0.5 wt. %, based on the wet weight of the added polymer.
